(19) United States
(12) Patent Application Publication
(10) Pub. No.: US 2011/0149773 A1
(43) Pub. Date: Jun. 23, 2011

(54) APPARATUS AND METHOD FOR RECEIVING DATA IN WIRELESS COMMUNICATION SYSTEM

(75) Inventors: Il-Gu Lee, Seoul (KR); Sok-Kyu Lee, Daejeon (KR)

(73) Assignee: ELECTRONICS AND TELECOMMUNICATIONS RESEARCH INSTITUTE, Daejeon (KR)

(21) Appl. No.: 12/969,272

(22) Filed: Dec. 15, 2010

(30) Foreign Application Priority Data
Dec. 17, 2009 (KR) 10-2009-0126133

(51) Int. Cl. H04W 24/00

(52) U.S. Cl. 370/252

(57) ABSTRACT

Provided are method and apparatus for receiving data in a wireless communication system. The method includes receiving data through one antenna or a plurality of reception antennas; measuring received signal power levels and a noise power level from the received data; calculating a gain control value of an automatic gain control process; compensating the measured received signal power levels based on the calculated gain compensation value; calculating a predetermined ratio based on the compensated received signal power levels and the noise power level; and restoring the received data using the calculated predetermined ratio.

### CROSS-REFERENCE TO RELATED APPLICATIONS

The present application claims priority of Korean Patent Application No. 10-2009-0126133, filed on Dec. 17, 2009, which is incorporated herein by reference in its entirety.

### BACKGROUND OF THE INVENTION

1. Field of the Invention

Exemplary embodiments of the present invention relate to a wireless communication system; and, more particularly, to apparatus and method for receiving data by accurately estimating a channel state of a wireless channel for transmitting data in a wireless communication system.

2. Description of Related Art

Many studies have been actively made for providing services with QoS (Quality of Service) to users in a next generation communication system. Particularly, many studies for a wireless local area network (WLAN) have been made through Institute of Electrical and Electronics Engineers (IEEE) 802.11 specification. Regarding a WLAN system, many studies for transmitting data through a wireless channel have been in progress. Lately, methods for transmitting and receiving data effectively using a limited wireless channel in an IEEE 802.11 system have been introduced.

Recently, an Orthogonal Frequency Division Multiplexing (OFDM) communication system has been applied to a wireless communication system. Such an OFDM communication system transmits and receives a mass amount of data through a wide bandwidth. In the OFDM communication system, each subcarrier of a wireless channel has an orthogonal property in order to transmit and receive a mass amount of data. In order to improve a data transmit rate of a limited wireless channel, the OFDM communication system determines a channel state of a wireless channel and control transmitting and receiving data based on the determined channel state of the wireless channel.

Meanwhile, applications of a terminal for receiving data from the above described systems have been diversified. Such a terminal has been advanced to receive a mass amount of data and to have high speed mobility. Accordingly, there are many methods studied for determining a channel state of a wireless channel. For example, methods for determining a channel state of a wireless channel using a Packet Error Ratio (PER), signal power, a signal to noise ratio (SNR) of a wireless channel have been introduced.

Among such methods, the PER based channel state determining method determines whether a data packet has an error or not by checking a Cyclic Redundancy Check (CRC) of the data packet in a Media Access Control (MAC) layer. If the number of accumulated error packets is greater than a predetermined threshold value, it is determined that a channel state of a wireless channel is poor. If a data packet error is not generated during the predetermined number of packets, it is determined that a channel state is good.

However, such a PER based wireless channel determining method has a disadvantage of a slow response time due to a time for determining a channel state. That is, since the PER based wireless channel determining method performs a process of determining a wireless channel state at a slow speed, high speed data transmission cannot be performed adaptively according to the variation of a channel environment. Further, it is difficult to use the PER based wireless channel state as an absolute channel state although it is comparatively easy to determine the wireless channel state based on PER because the number of accumulated error packets is used to determine the channel state.

Further, the signal power based channel state determining method determines a wireless channel state by measuring signal intensities of a digital signal and an analog signal for a data packet transmitted through a wireless channel. Since the power of the digital signal converted from the data packet has a constant value due to automatic gain control, the wireless channel state is determined based on a signal saturation state and a gain control value of the digital signal. However, the signal power based channel state determining method cannot effectively determine the wireless channel statue because it simply considers signal magnitude without considering an SNR thereof.

In case of an analog signal power based channel state determining method, it requires an additional device such as an Analogue to Digital Converter (ADC) for converting analog signal power to a digital signal because a Radio Frequency (RF) receiver measures the analog signal power. Accordingly, the analog signal power based channel state determining method has disadvantages of a high system complexity, a high manufacturing cost, and a high power consumption. Further, a signal power measuring result may be inaccurate due to an analog circuit used to measure the signal power. A digital circuit may give a more accurate result compared with an analog device. Accordingly, the analog signal power based channel state determining method has an inaccuracy problem.

The frequency domain SNR based channel state determining method measures the SNR by calculating an average value of carrier frequency signal power used in a frequency domain using a preamble. However, the frequency domain SNR based channel state determining method requires a number of multipliers and adders for calculating an average value of the carrier frequency signal power in order to improve the accuracy of measuring an SNR. Accordingly, the frequency domain SNR based channel state determining method has disadvantages of a high system complexity, a high manufacturing cost, and high power consumption. Further, since noise signal power in a carrier frequency signal used for measuring an SNR includes noise errors generated from an ADC to a demodulator in a data receiving apparatus, the measured SNR may not be an actual SNR of a received signal. Accordingly, it is difficult to measure an accurate SNR and to accurately determine the channel state of the wireless channel.

As described above, the typical methods for determining a channel state have many limitations in speed, accuracy, complexity, and power consumption. Therefore, there have been demands for developing a method for accurately determining a channel state of a wireless channel with a simple structure, low power consumption, and a high speed and receiving data based on the determined accurate channel state.

### SUMMARY OF THE INVENTION

An embodiment of the present invention is directed to an apparatus and method for receiving data in a wireless communication system.

Another embodiment of the present invention is directed to an apparatus and method for receiving data by accurately determining a channel state of a wireless channel where data is transmitted at high speed in a wireless communication system.

Another embodiment of the present invention is directed to an apparatus and method for receiving data by accurately determining a wireless channel state, having a simple structure, and requiring low power consumption using an analog signal of data transmitted through a wireless channel in a wireless communication system.

Another embodiment of the present invention is directed to data receiving apparatus and method for improving accuracy in calculating a signal-to-noise ratio (SNR) and expanding a channel estimating range by adaptively using a time domain based SNR calculation method or in a frequency domain SNR calculation method according to a channel state.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, a method for receiving data in a wireless communication system includes receiving data through one antenna or a plurality of reception antennas; measuring received signal power levels and a noise power level from the received data; calculating a gain control value of an automatic gain control process; compensating the measured received signal power levels based on the calculated gain compensation value; calculating a predetermined ratio based on the compensated received signal power levels and the noise power level; and restoring the received data using the calculated predetermined ratio.

The predetermined ratio may be calculated by controlling the received signal power level and the noise power level in a time domain and a frequency domain.

In accordance with an embodiment of the present invention, an apparatus for receiving data in a wireless communication system, includes an amplifier configured to receive data through one antenna or a plurality of reception antennas and amplify the received data; a measuring unit configured to measure a received signal power level and a signal power level from the amplified data; an automatic gain controller configured to perform an automatic gain control process for the measured received signal power level and compensate the measured received signal power level based on a gain control value of the automatic gain control process; and a calculator configured to calculate a predetermined ratio based on the compensated received signal power level and the noise power level.

The predetermined ratio may be calculated by controlling the received signal power level and the noise power level in a time domain and a frequency domain.

### BRIEF DESCRIPTION OF THE DRAWINGS

FIG. 1 is a block diagram illustrating a data receiving apparatus in a wireless communication system in accordance with an embodiment of the present invention.

FIG. 2 is a state transition diagram illustrating an automatic gain control process of a data receiving apparatus in a wireless communication system in accordance with an embodiment of the present invention.

FIG. 3 is a diagram illustrating circuit blocks for an automatic gain control process and an SNR calculation process in a data receiving apparatus in a wireless communication system in accordance with an embodiment of the present invention.

FIG. 4 is a diagram illustrating a saturation state sensor of a data receiving apparatus in a wireless communication system in accordance with an embodiment of the present invention.

FIGS. 5 to 8 are diagrams for describing SNR calculation in a data receiving apparatus in a wireless communication system in accordance with an embodiment of the present invention.

FIGS. 9 to 15 are diagrams illustrating an SNR calculated by a data receiving apparatus in a wireless communication system in accordance with an embodiment of the present invention.

FIG. 16 is a flowchart illustrating a method for calculating an SNR of a data receiving apparatus in a wireless communication system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

Embodiments of the present invention relate to apparatus and method for receiving data in a wireless communication system such as a Wireless Local Area Network (WLAN) system and an Institute of Electrical and Electronics Engineers (IEEE) 802.11 system. Although the embodiments of the present invention will be described based on the WLAN system or the IEEE 802.11 system through the specification, it is not limited thereto. The embodiments of the present invention may be applied to other communication system.

Further, embodiments of the present invention relate to apparatus and method for receiving data by determining a channel environment of a wireless channel of transmitting data in a wireless communication system. That is, the embodiments of the present invention relate to apparatus and method for determining a channel state of a wireless channel. In the embodiments of the present invention, an Orthogonal Frequency Division Multiplexing (OFDM) wireless communication system accurately determines a channel state of a wireless channel for transmitting data at high speed in a time domain using a received data signal. Based on the accurately determined channel state, the OFDM wireless communication system estimates a channel and restores received data. In the embodiments of the present invention, additional devices for determining a channel state are minimized. That is, the apparatus and method for receiving data by determining a wireless channel state in accordance with an embodiment of the present invention accurately determines a wireless channel state using typical constituent elements previously included in a receiver of a wireless communication system with low power consumption and stably receives data in consideration of the determined channel state.

A data receiving apparatus in accordance with an embodiment of the present invention includes an Automatic Gain Controller (AGC) and a reception power calculator for calculating a received signal power level of a signal received through a receiving antenna. Further, the data receiving apparatus in accordance with an embodiment of the present invention calculates a received signal power level of a signal received through a reception antenna in consideration of power increments in power amplifiers and a power level of a gain-controlled signal. Here, the amplifiers may be a RF power amplifier and a baseband power amplifier in a receiver, and the gain-controlled signal is a signal converted to a digital signal by an Analogue to Digital Converter (ADC) and gain-controlled by an Automatic Gain Controller (AGC). Then, the data receiving apparatus in accordance with an embodiment of the present invention calculates a ratio between the calculated signal power and a previously calculated noise power, such as a signal to noise ratio (SNR). The data receiving apparatus in accordance with an embodiment of the present invention quickly and accurately determines a channel state of a wireless channel in a time domain based on the calculated SNR. The data receiving apparatus in accordance with an embodiment of the present invention estimates a wireless channel and restores received data using the calculated SNR. Although the data receiving apparatus in accordance with an embodiment of the present invention will be described based on calculating SNR of a wireless channel and determining a channel state of a wireless channel based on the calculated SNR, the present invention is not limited thereto. The data receiving apparatus in accordance with an embodiment of the present invention may be applied identically to when a Packet Error Ratio (PER) or a received signal power is calculated and used to determine a channel state.

The data receiving apparatus in accordance with an embodiment of the present invention uses typical constituent elements such as a AGC, which were previously included in a typical receiver, in order to determine a channel state. Accordingly, the data receiving apparatus in accordance with an embodiment of the present invention has low structural complexity and requires low power consumption. In case of the data receiving apparatus in accordance with an embodiment of the present invention includes a plurality of reception antennas such as a multi-mode wireless communication system, the data receiving apparatus in accordance with an embodiment of the present invention calculates a further reliable SNR using a plurality of reception path signals and further accurately determines a channel state using the calculated SNR. Therefore, the data receiving apparatus in accordance with an embodiment of the present invention can increase a data transmit rate and a data processing rate. As a result, the data receiving apparatus in accordance with an embodiment of the present invention can improve an overall system performance. Although the data receiving apparatus in accordance with an embodiment of the present invention will be described based on a system having a single reception antenna, for example, as calculating an SNR based on one signal reception path to determine a channel state, the present invention is not limited thereto. The data receiving apparatus in accordance with an embodiment of the present invention can be applied to a multi-antenna wireless communication system that determines a channel state by calculating an SNR using signals received through multiple signal reception paths.

Further, the data receiving apparatus and method in accordance with embodiments of the present invention accurately determines a channel state of a wireless channel for transmitting data in a wireless communication system by calculating an SNR of an analog signal through an adaptive algorithm according to a power level of an analog signal received at a RF receiver in a time domain. Accordingly, the data receiving apparatus in accordance with an embodiment of the present invention stably receives a mass amount of data. Here, the data receiving apparatus in accordance with an embodiment of the present invention determines a channel state by calculating an SNR of a received signal through an adaptive algorithm in order to improve an overall performance of a wireless communication system.

When a signal input to an ADC of the data receiving apparatus is in a saturation state, it is difficult to accurately measure a signal power level of the input signal. Accordingly, the data receiving apparatus in accordance with an embodiment of the present invention controls the input signal to be included in an ADC dynamic range of the ADC by performing an automatic gain control process on a signal received by a RF receiver and calculates an SNR of the gain controlled signal in consideration of a gain control value of the AGC. That is, since the gain controlled signal is input to the ADC, the data receiving apparatus in accordance with an embodiment of the present invention can accurately determine a channel state by calculating an SNR of a signal input to the ADC.

The data receiving apparatus in accordance with an embodiment of the present invention gain-controls and amplifies not only received data signals but also a noise signal thereof. Accordingly, it is necessary to determine an automatic gain control value of the AGC in order to accurately determine a channel state through the SNR. That is, in order to determine the gain control value of the AGC, the data receiving apparatus in accordance with an embodiment of the present invention determines the gain control value by measuring a received signal power level through interaction of the AGC and calculates an SNR using the determined gain control value. Here, the data receiving apparatus in accordance with an embodiment of the present invention decides a range of the calculated SNR adaptively to a channel state by interacting with the AGC and also accurately calculates a noise signal power level.

Since the data receiving apparatus and method in accordance with an embodiment of the present invention can accurately determine a channel state of a wireless channel, the data receiving apparatus and method in accordance with an embodiment of the present invention enables a wireless communication system to provide a service with various QoSs at a high speed using limited frequency resource and transmission signal power. Here, the wireless communication system may include a WLAN system, an IEEE 802.11 system, or an IEEE 802.11 VHT (Very High Throughput) system.

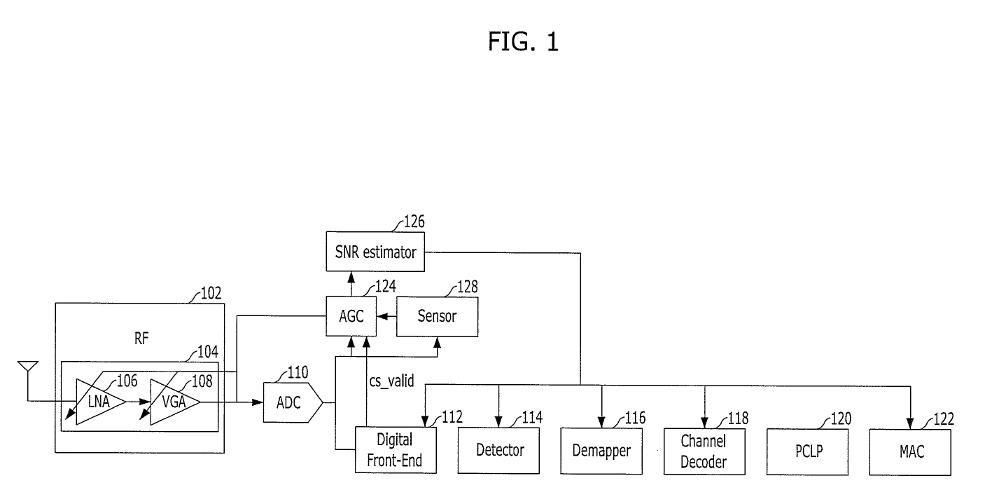

Further, the data receiving apparatus in accordance with an embodiment of the present invention uses typical constituent elements previously included in a typical receiver to determine a channel state of a wireless channel. Accordingly, the data receiving apparatus in accordance with an embodiment of the present invention accurately determines a channel state with an optimal performance according to a wireless channel environment with low power consumption. Accordingly, the data receiving apparatus in accordance with an embodiment of the present invention stably performs receiving and transmitting data at high speed through controlling transmission power, controlling a level of MCS (modulation and coding scheme), controlling a data transmission mode and a data transmit rate, controlling modulation and demodulation of received data, and controlling a filter coefficient of estimating a carrier frequency offset (CFO). Hereinafter, a data receiving apparatus in accordance with an embodiment of the present invention will be described with reference to FIG. 1.

FIG. 1 is a diagram schematically illustrating a data receiving apparatus in a wireless communication system in accordance with an embodiment of the present invention.

Referring to FIG. 1, the data receiving apparatus includes a Radio Frequency (RF) receiver 102, an analogue-to-digital converter (ADC) 110, a digital front-end 112, a sensor 128, an Automatic Gain Controller (AGC) 124, and a Signal-to-Noise Ratio (SNR) estimator 126. The RF receiver 102 receives data through a plurality of reception antennas. Here, the data is transmitted by a unit of a packet and transmitted through a wireless channel. The ADC 110 receives the data from the RF receiver 102 and converts the data from analog to digital. The digital front-end 112 receives the digital data from the ADC 110 and transmits the digital data to data processors of the data receiving apparatus in order to process the digital data. The sensor 128 measures a signal power of the digital data. The AGC 124 controls a gain in order to control the analog signal of the data within an ADC dynamic range of the ADC 110 and calculates a gain control value between input and output data of the ADC 110, which are the analog data and the digital data. The SNR calculator 126 calculates a signal to noise ratio (SNR) of the analog data based on the gain control value from the AGC 124 and the calculated signal power of the digital data from the sensor 128.

The data receiving apparatus in accordance with an embodiment of the present invention further includes a detector 14 for detecting original data from the digital data using the calculated SNR, a demapper 116 for demapping the detected data, a channel decoder 118 for decoding the demapped data, a Physical layer Convergence Protocol 120 for processing the decoded data in a physical (PHY) layer, and a Media Access Control protocol 122 for processing the PHY processed data in a Media Access Control (MAC) layer.

As described above, the data receiving apparatus of the wireless communication system in accordance with an embodiment of the present invention includes data processors such as the RF receiver 102, the ADC 110, the AGC 124, the SNR estimator 126, the detector 114, the demapper 116, and the channel decoder 118, in order to convert a demodulated RF signal to a digital signal, compensate a signal distorted at a wireless channel and analog circuit, and detect information through decoding a signal encoded and transmitted from a transmitter.

The RF receiver 120 includes an amplifier 104 for amplifying a data signal attenuated in a wireless channel. The amplifier 104 includes a Low Noise Amplifier (LNA) 106 and a Voltage Gain Amplifier (VGA) for improving a reception sensitivity of the received analog signal. The LNA 106 and the VGA 108 amplify a received signal when the data receiving apparatus receives a signal having a low signal power level because the signal is attenuated while the signal is travelling through a wireless channel. The LNA 106 and the VGA 108 attenuate a received signal when the data receiving apparatus receives a signal having a high received signal power level because a transmitter amplifies the signal to transmit.

As described above, the LNA 106 and the VGA 108 perform amplifying or attenuating a received signal of data transmitted through a wireless channel by an automatic gain control scheme in response to the control of the AGC 124. According to the automatic gain control scheme, the sensor 128 senses a saturation state of a baseband signal which is received and demodulated at the RF receiver 102, and measures the received signal power. Then, the AGC 124 controls the received signal power level of the demodulated baseband received signal to be included in a dynamic range of the ADC 110. That is, the AGC 124 calculates a gain control value and feeds the calculated gain control value back to the amplifiers 106 and 108 of the RF receiver 102. The LNA 106 and the VGA 108 amplify or attenuate the baseband received signal by controlling an amplification gain value based on the feedback gain control value. Here, the amplification gain values of the LNA 106 and the VGA 108 are calculated according to the gain control value calculated at the AGC 124, and the AGC 125 may calculate the gain control value and the amplification gain value.

For example, when a data receiving apparatus in accordance with an embodiment of the present invention receives signals having a power level of −20 dBm to −82 dBm through a wireless channel in a wireless communication system, the LNA 106 performs a low gain mode for signals having a power level of −20 dBm to −30 dBm, performs an intermediate gain mode for signal having a power level of −30 dBm to −45 dBm, and performs a high gain mode for signals having a power level of −45 to −82 dBm, in order to control the SNR calculator 126 to accurately calculate an SNR of the received signal. After the LNA 106 controls the power level of the analog received signal to be included in the ADC dynamic range of the ADC 110 by controlling the gain control value, the VGA 108 controls the power level of the analog received signal, which was controlled by the ADC 110, based on the gain control value to have a predetermined power level included in an ADC dynamic range of the ADC 110. Here, since the received signal is in the ADC dynamic range of the ADC 110, not in a saturation state, by the LNA 106, the AGC 124 measures the received signal power level through the sensor 128 and calculates the gain control value in consideration of a peak signal margin according to a communication protocol of a wireless communication system in order to enable the VGA 108 to control the power level of the received signal to a predetermined target power level through an amplification gain. Here, the target power level means a power level of a received signal required to normally and optimally receive data transmitted through a wireless channel. When the measured received signal power level is equivalent to the target power level, the data receiving apparatus in accordance with an embodiment of the present invention can calculate the most accurate SNR. Such an accurate SNR enables the data receiving apparatus to perform an optimal data receiving operation.

As described above, the sensor 128 calculates a gain control value for automatic gain control of the AGC 124 and senses a received signal of data transmitted through a wireless channel for controlling an amplification gain using the gain control value of the amplifiers 106 and 108 of the RF receiver 102. That is, the sensor 128 performs carrier sensing. Particularly, when a data receiving apparatus in accordance with an embodiment of the present invention senses data reception through a wireless channel, the data receiving apparatus changes an operation state of constituent elements. For example, the data receiving apparatus in accordance with an embodiment of the present invention normally receives data by transiting to a gain control state for performing an automatic gain control process. For this, the sensor 128 performs carrier sensing.

The sensor 128 uses a received power based carrier sensing scheme, a correlation based carrier sensing scheme, and a saturation state based carrier sensing scheme. The received power based carrier sensing scheme compares a power level of a received signal with a predetermined threshold value. When the data receiving apparatus in accordance with an embodiment of the present invention receives a signal having a power level greater than the predetermined threshold value, the data receiving apparatus in accordance with an embodiment of the present invention determines that a signal is received and transits to a gain control state. The correlation based carrier sensing scheme senses signal reception by calculating autocorrelation and cross correlation of a repeat signal sequence such as preamble included in a data transmitted through a wireless channel and transits to a gain control state. When the data receiving apparatus receives a signal having a power level greater than a predetermined threshold value, the saturation state based carrier sensing scheme has difficulties to calculate a power level and signal correlation of a received signal because the power level thereof exceeds an ADC dynamic range of the ADC 110. Accordingly, the saturation state based carrier sensing scheme senses a saturation state of a received signal and informs other constituent elements of the data receiving apparatus. That is, the saturation state based carrier sensing scheme senses an excess of an ADC dynamic range of the ADC 110 and informs the AGC 124.

In order to enable the data receiving apparatus in accordance with an embodiment of the present invention to stably and normally receive data, the AGC 124 controls a gain of a received signal adaptively to a channel environment that varies according to the movement of a terminal or adaptively to a signal distorted through a wireless channel. For example, in a WLAN system or an OFDM wireless communication system for transmitting a packet at a high speed, a packet transmitted through a wireless channel is influenced by a channel environment. The AGC 124 calculates an SNR of a received signal of a packet transmitted according to such a channel environment, restores the transmitted packet in consideration of the calculated SNR, and calculates a gain control value to control power amplification of the amplifiers 106 and 108. By the gain control value, the amplifiers 106 and 108 maximally use the ADC dynamic range of the ADC 110 and output a controlled signal with SNR calculation not limited according to a power level of a received signal.

The AGC 124 performs automatic gain control on each packet of data when the data receiving apparatus receives data transmitted through a wireless channel. That is, the AGC 124 calculates a gain control value per each packet. Based on the calculated gain control value, the SNR calculation of the SNR estimator 126, the channel state determination according to the SNR calculation, and the amplification gain control and the amplification of the received signal of the amplifiers 106 and 108 are performed per each packet.

Accordingly, the data receiving apparatus in accordance with an embodiment of the present invention is optimized quickly according to a channel environment, determines a channel state at a high speed, and processes data at high speed, thereby normally and stably receiving data. That is, the data receiving apparatus in accordance with an embodiment of the present invention quickly performs operations for optimally receiving data according to a channel environment and stably and accurately receives data even during a short preamble of a packet with an optimal decoding performance.

Although it is not shown in the accompanying drawings, the AGC 124 includes an automatic gain control unit, a digital variable gain amplifier, and a sensor for sensing a saturation state of a received signal for the ADC 110 through carrier sensing of the sensor 128. The AGC unit includes a power measuring unit for measuring the largest power level of a signal received through a single reception antenna or among a plurality of reception antennas by measuring a power level of a received signal for a predetermined time, a gain controller for calculating a gain compensation value by comparing the measure power level with a predetermined threshold value, and an amplification controller for controlling an amplification gain value of the amplifiers 106 and 108 of the RF receiver 102, especially the amplification gain value of the LNA 106, by confirming the gain compensated value. Hereinafter, the automatic gain control of the AGC 124 will be described in detail.

At first, a power level of a received signal is measured during a predetermined time before calculating a gain control value for the automatic gain control of the AGC 124 and for the amplification gain control of the amplifiers 106 and 108. If the measured power level of the received signal is in a saturation state while measuring a power level of the received signal, the data receiving apparatus in accordance with an embodiment of the present invention interrupts measuring a power level of a received signal and downs a power level of a received signal by reducing the amplification gain value of the amplifiers 106 and 108 as much as a predetermined amplification gain value setup as a programmable register value through a gain control value of the AGC 124. If the measured power level of the received signal for the ADC 110 is not in a saturation state and if the measured power level of the received signal is smaller than a predetermined target power level as described above, the data receiving apparatus in accordance with an embodiment of the present invention amplifies the received signal as much as the predetermined amplification gain value. If the measured power level of the received signal for the ADC 110 is not in a saturation state and if the measured power level of the received signal is greater than the predetermined target power level, the data receiving apparatus in accordance with an embodiment of the present invention reduces the received signal as much as the predetermined amplification gain value. Such a gain control process is performed adaptively according to the measured power level of the received signal. That is, the automatic gain control process can be performed more quickly as the power level increases.

As described above, the amplifiers 106 and 108 control the amplification gain of the received signal based on the calculated gain control value from the AGC 124. The gain control value calculation and the amplification gain control are repeatedly performed according to a power level of a received signal by amplification gain control. In other words, the gain control value of the AGC 124 and the amplification gain value of the amplifiers 106 and 108 are updated as follows. When a power level of the amplification gain controlled signal from the amplifiers 106 and 108 is measured by the gain control value, the AGC 124 calculates a gain control value and feeds back the gain control value to the amplifiers 106 and 108. It is repeatedly performed until a power level of the amplification gain controlled signal from the amplifiers 106 and 108 becomes smaller than the predetermined target power level.

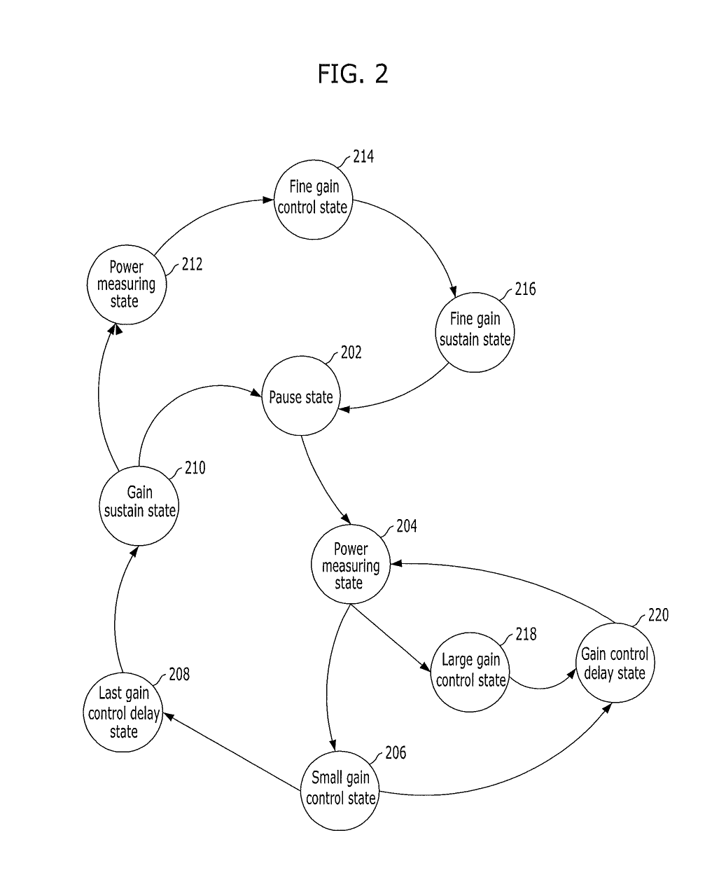

An initial amplification gain value of the amplifiers 106 and 108 is decided by a predetermined programmed register value. When a data receiving apparatus in accordance with an embodiment of the present invention receives data using multiple antennas, amplification gain control may be performed once more in order to further accurately and stably receive data. In case of multiple antennas, the amplification gain control process measures a power level of a received signal again during a predetermined time setup for measuring a power level of the received signal, compensates a difference between the measured power level and the predetermined target power level, sustains an amplification gain during a packet period for measuring the power level, and transits to a pause state after the packet period ends. A gain sustaining period is decided by a unit of a packet. Here, the gain sustaining period means a period sustaining a predetermined gain. That is, a period that the amplifiers 106 and 108 apply an amplification gain value controlled by a feedback gain control value from the AGC is decided by a packet unit. Here, the period is controlled by an automatic gain control mode value of the programmable register. Hereinafter, an automatic gain control process of a data receiving apparatus in a wireless communication system in accordance with an embodiment of the present invention will be described with reference to FIG. 2.

FIG. 2 is a state transition diagram illustrating an automatic gain control process of a data receiving apparatus in a wireless communication system in accordance with an embodiment of the present invention. The state transition diagram illustrates the transition of operation states of the AGC 124 when the data receiving apparatus in accordance with an embodiment of the present invention receives data in a unit of a packet through an automatic gain control process.

Referring to FIG. 2, an operation state of the automatic gain control process of the AGC 124 transits according to a preamble of data transmitted in a unit of a packet through a wireless channel. In case of a preamble of a data packet supporting multiple antennas, that is, when data is received through multiple antennas, a gain sustain state 210 for sustaining an amplification gain transits to a power measuring state 212 for measuring a power level of a received signal in order to perform an amplification gain control process once more. In case of a preamble of a data packet not supporting multiple antennas, that is, when data is received through a single reception antenna, a pause state 202 is maintained until a next data packet is received. Here, all operation states of the automatic gain control process transit to the pause state 202 when a gain control activation index for the automatic gain control process is set to 0.

When the gain control activation index is activated at the pause state 202, the pause state 202 transits to a power measuring state 204 for measuring a power level of a received signal for a predetermined time setup as a unit of a packet. Here, the power level of the received signal is measured as an accumulated value of a real number part and an imaginary number part of each signal received through each antenna. The sampling number of the accumulated value is decided by an operation frequency of the sensor 128 that measures the power level of the received signal. When the power level measured by the sensor 128 is a saturation state, that is, when the measured power level is not in an ADC dynamic range of the ADC 110, an amplification gain value update process of the amplifiers 106 and 108 is performed according to a gain control value decided by the AGC 124.

That is, when the measured power level of the received signal is in a saturation state, the power measuring state 204 is interrupted and transits to a large gain control state 218. In the large gain control state 204, the amplification gain value of the amplifiers 106 and 108 is reduced as much as a large gain value according to a gain control value decided by the AGC 124. In a gain control delay state 220, the amplifiers 106 and 108 receive a received signal and amplify or attenuate the received signal with an amplification gain value. Then, a power level of the received signal is measured at the power measuring state 104.

When the measured power level of the received signal is not in a saturation state, the power measuring state 204 transits to a small gain control state 206. Then, the measured power levels of the received signals are compared to each other, and the AGC 124 decides a gain control value using the largest power level among the measured power levels of the received signals as a reference power level. Here, the AGC 124 decides a gain control value in consideration of a difference between the largest power level of the received signal and the target power level. The amplifiers 106 and 108 update an amplification gain value based on the decided gain control value. In a last gain control delay state 208, the amplifiers 106 and 108 receive a received signal and amplify or attenuate the received signal with the amplification gain value. Then, the last gain control delay state 208 transits to the gain sustain state 210. The amplifiers 106 and 108 receive and amplify a received signal by sustaining the amplifier gain value.

While the amplification gain value is sustained in the gain sustain state 210, the gain sustain state 210 transits to a power measuring state 212 or a pause state 202. When the gain sustain state 210 transits to the power measuring state 212, power levels of amplified received signals from the amplifiers 106 and 108 are measured. Particularly, a power level of an amplified received signal from the VGA 108 is measured. Then, the power measuring state 212 transits to a fine gain control state 214. In the fine gain control state 214, an amplification gain value of the VGA 108 is updated. After updating, the fine gain control state 214 transits to a fine gain sustain state 216 for sustaining the updated amplification gain. In the fine gain sustain state 216, a received signal is amplified. While the amplification gain value is sustained in the fine gain sustain state 216, the fine gain sustain state 216 transits to the pause state 202.

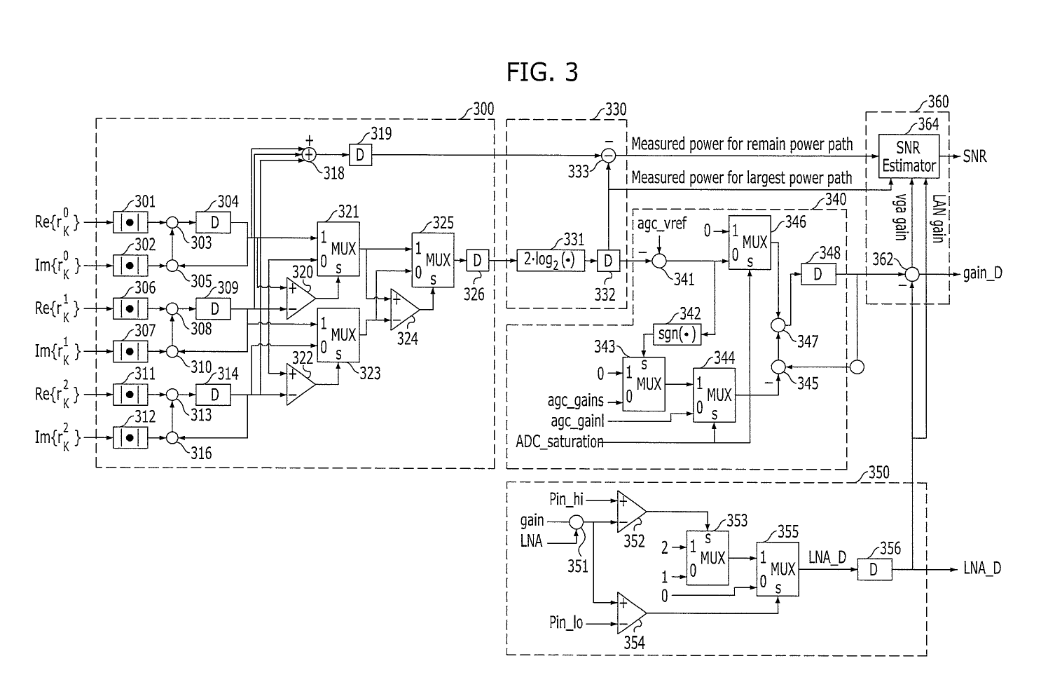

As described above, the data receiving apparatus in accordance with an embodiment of the present invention performs an automatic gain control process by measuring power levels of received signals for data transmitted through a wireless channel by transiting the operation states according to the state transition diagram of FIG. 2. Through the above described automatic gain control process, the data receiving apparatus in accordance with an embodiment of the present invention normally and optimally receives data transmitted through a wireless channel. Hereinafter, a circuit block for automatic gain control and SNR estimation in a data receiving apparatus in accordance with an embodiment of the present invention will be described in detail with reference to FIG. 3.

FIG. 3 is a diagram illustrating circuit blocks for automatic gain control and SNR estimation in a data receiving apparatus of a wireless communication system in accordance with an embodiment of the present invention. FIG. 3 schematically illustrates structures of an AGC 124 for performance an automatic gain control process and an SNR estimator 126 for estimating an SNR in the data receiving apparatus of FIG. 1.

Referring to FIG. 3, the AGC 124 includes a power measuring unit 300, a converter 330, a VGA gain control unit 340, and LNA mode control unit 350. The power measuring unit 300 calculates absolute values such as power levels of received signals rₖ, which are received through a plurality of antennas and amplified in the amplifiers 106 and 108. The power measuring unit 300 determines a received signal having the largest power level among the received signals and calculates an average power level of the remaining received signals by comparing the calculated absolute values of the power levels of the received signals. The converter 330 converts the largest power level of the received signal to a log value to accurately and effectively calculate an SNR. The VGA gain control unit 340 calculates and compensates a gain compensation value by comparing the log value, which is the largest power level of the received signal, with a predetermined reference value. The LNA mode control unit 350 controls an amplification gain of the amplifiers 106 and 108 such as the LNA 106 based on the gain compensated value.

The power measuring unit 300 includes absolute value calculators 301, 302, 306, 307, 311, and 312 for calculating absolute values of received signals in order to calculate power levels of received signals rₖ, which are received through a plurality of antennas and amplified by the amplifiers 106 and 108, and adders 303, 305, 308, 310, 313, and 316 for adding the calculated absolute values of the received signals with absolute values of received signals received at a previous frame. The power measuring unit 300 further includes delays 304, 309 and 314 for outputting the added absolute values, comparators 320, 322, and 324 for comparing power levels of received signals from the plurality of antennas, MUXs 321, 323, and 325 for determining a received signal having the largest power level among the received signals from the plurality of antennas according to the comparison results of the comparators 320, 322, and 3241, a delay 326 for outputting the decided power level of the received signal having the largest power level, an adder 318 for adding power levels of the remaining received signals among the received signals from the plurality of antennas except the received signal having the largest power level; and a delay 319 for outputting the sum of power levels of the remaining received signals.

The converter 330 includes a log converter 331, a delay 332, and an operator 333. The log converter 331 converts the power magnitude of the received signal having the largest power level to a log value. The delay 332 outputs the power magnitude of the receiving signal having the largest power level by delaying the log value calculated from the log converter 331. The operator 333 outputs an average power of the remaining received signals by calculating a difference between the sum of power magnitudes of the remaining received signals and the delayed log value, which is the power magnitude of the received signal having the largest power level. As described above, the converter 330 expands a gain control range of the AGC 124 by converting the power magnitude of the received signal to a log value. The converter 330 also reduces the number of bits for gain control when the AGC 124 is implemented as a hardware device.

The VGA gain controller 340 includes an operator 341 for comparing the delayed log value from the delay 332, which is the power magnitude of the received signal having the largest power level, with a predetermined reference value agc_vref, an operator 342 for calculating a result of a function sgn( ) with the compared power of the received signal having the largest power level from the operator 341, MUXs 343 and 344 for calculating a gain compensation value based on the sgn result from the operator 342, the comparison result from the operator 341, gain control values agc_gains and agc_gainl, and a saturation value ADC_saturation of the AGC 110, a MUX 346 for deciding a power level of a received signal, operators 345 and 347 for calculating a gain compensation value corresponding the decided power level of the received signal, and a delay 348 for outputting the gain compensation value.

The LNA mode control unit 350 includes an operator 351 for compensating an LNA gain of an amplified received signal from the LNA 106 and the amplification gain, comparators 352 and 354 for comparing the compensated power level of the received signal with the maximum power level Pin_hi and the minimum power level Pin_lo of the received signal, MUXs 353 and 355 for deciding an amplification gain value LNA_D of the LNA 106 according to the comparison result, and a delay 356 for outputting the decided magnitude gain value LNA_D of the LNA 106.

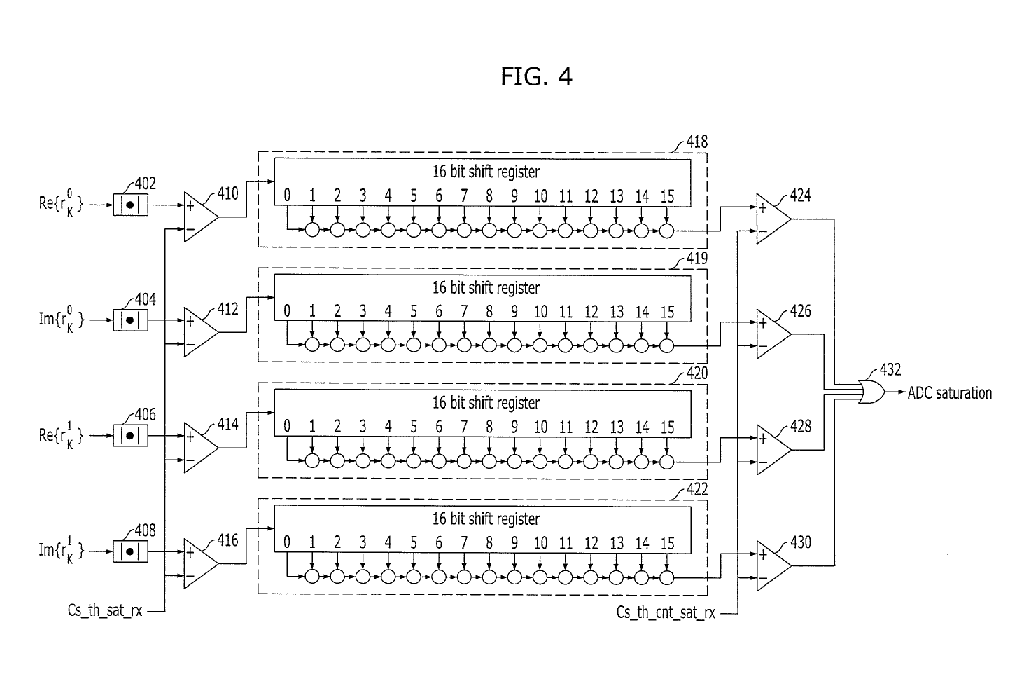

The SNR estimator 126 includes an SNR calculator 360 for calculating an SNR using the calculated gain control value from the VGA gain control unit 340 and the LNA mode control unit 350 and the measured power level of the received signal. The SNR calculator 360 includes an operator 362 and a calculator 364. The operator 362 calculates an amplification gain value vga_gain of the VGA 108 using the gain compensation value outputted from the VGA gain control unit 340 and the LNA mode control unit 350 and the amplification gain value LNA_D of the LNA 106. The calculator 364 calculates an SNR based on the power magnitude of a received signal having the largest power level, the average power of the remaining received signals, and the amplification gain values of the amplifiers 106 and 108. Hereinafter, determining of a saturation state of a received and amplified signal in a wireless communication system in accordance with an embodiment of the present invention will be described in detail with reference to FIG. 4.

FIG. 4 is a diagram illustrating a saturation state detecting structure of a data receiving apparatus of a wireless communication system in accordance with an embodiment of the present invention. FIG. 4 schematically illustrates a structure of an AGC 124 in the data receiving apparatus of FIG. 1. Here, the AGC 124 determines whether signals, which are received through a plurality of antennas and amplified by the amplifiers, are included in an ADC dynamic range of the ADC 110 while performing automatic gain control and SNR estimation operations.

Referring to FIG. 4, the AGC 124 includes calculators 402, 404, 406, and 408 for calculating absolute values such as power levels of received signals rₖ, which are received through a plurality of antennas and amplified by the amplifiers 106 and 108, and comparators 410, 412, 414, and 416 for determining saturation states of the received signals by comparing the measured power levels of the received signal with a predetermined saturation state reference value Cs_th_sat_rx of the ADC 110. The AGC 124 further includes shift registers 418, 419, 420, and 422 for buffering the comparison result for a predetermined time, comparators 424, 426, 428, and 430 for comparing the buffered power levels of the received signals with the predetermined saturation state reference value Cs_th_cnt_sat_rx of the ADC 110, and a determining unit 432 for determining a saturation state of a received signal based on the comparison result and outputting the determination result ADC saturation.

Here, the result of determining a saturation state of the signals rₖ which are received through the plurality of antennas and amplified by the amplifiers 106 and 108 is input to the VGA gain control unit 340 shown in FIG. 3. The AGC 124 calculates a gain control value and an amplification gain value of the amplifiers 106 and 108 in consideration of the saturation state of the received signal. The SNR calculator 126 calculates an SNR for the received and amplified signals based on the calculated gain control value and the amplification gain value of the amplifiers 106 and 108.

That is, in the data receiving apparatus in accordance with an embodiment of the present invention, the AGC 124 calculates an amplification gain value of the amplifiers 106 and 108 based on amplified power levels of received signals from the amplifiers 106 and 108, which are input to the ADC 110, and calculates an overall amplification gain value based on whether the received signals are saturated and based on a gain control value by a large amplification gain loop or by a small amplification gain loop. The AGC 124 calculates an amplification gain value of the LNA 106 based on the calculated overall amplification gain value and calculates an amplification gain value of the VGA 108 based a difference between the calculated amplification gain value of the VGA 108 and the overall amplification gain value.

A boundary of a power level of a received signal is decided by an amplification gain value of the amplifiers 106 and 108. For example, when the boundary of a power level of a received signal is decided −45 dBm and −24 dBm by an amplification gain value of the LNA 106, the amplification gain value of the LNA 106 is a high amplification gain value. That is, the LNA 106 operates as a high gain mode. When a calculated power level of a received signal amplified by the LNA 106 is larger than −45 dBm and smaller than −24 dBm, an amplification gain value of the LNA 106 is setup as an intermediate amplification gain value. That is, the LNA 106 operates as an intermediate gain operation mode. When the calculated power level of a received signal amplified by the LNA 106 is larger than −24 dBm, an amplification gain value of LNA 106 is setup as a low amplification gain value. The LNA 106 operates as a low gain operation mode. As described above, a next amplification gain value of the LNA 106 to be setup can be quickly determined based on the current amplification gain value of the LNA 106 and the calculated power level of the received signal amplified by the LNA 106. That is, the gain mode can be quickly determined.

Herein, an estimated power level of a received signal amplified by the LNA 106 with a predetermined amplification gain value is decided by a difference between an initial amplification gain value dBm of the LNA 106 and a predetermined target power level amplification gain value dBm or a current amplification gain value of the LNA 106. The amplification gain value of the LNA 106 is decided by a result of comparing the boundary of a power level of a received signal amplified by the LNA 106 (an ADC dynamic range of the ADC 110) and the estimated power level. For example, when the estimated power level is smaller than an upper boundary value (a high gain boundary value of the LNA 106), an amplification gain value of the LNA is setup as a high gain amplification gain value. That is, the LNA 106 operates as a high gain operation mode. When the estimated power level is in between the upper boundary value and a lower boundary value (a low gain boundary value of the LNA 106), an amplification gain value of the LNA 106 is setup as an intermediate gain amplification value. That is, the LNA 106 operates as an intermediate operation mode. When the estimated power level is larger than the low boundary value, an amplification gain value of the LNA 106 is setup as a low amplification gain value. That is, the LNA 106 operates as a low gain operation mode. As described above, the amplification gain value of the VGA 108 is decided by difference between the calculated overall amplification gain value and the amplification gain value of the LNA 106.

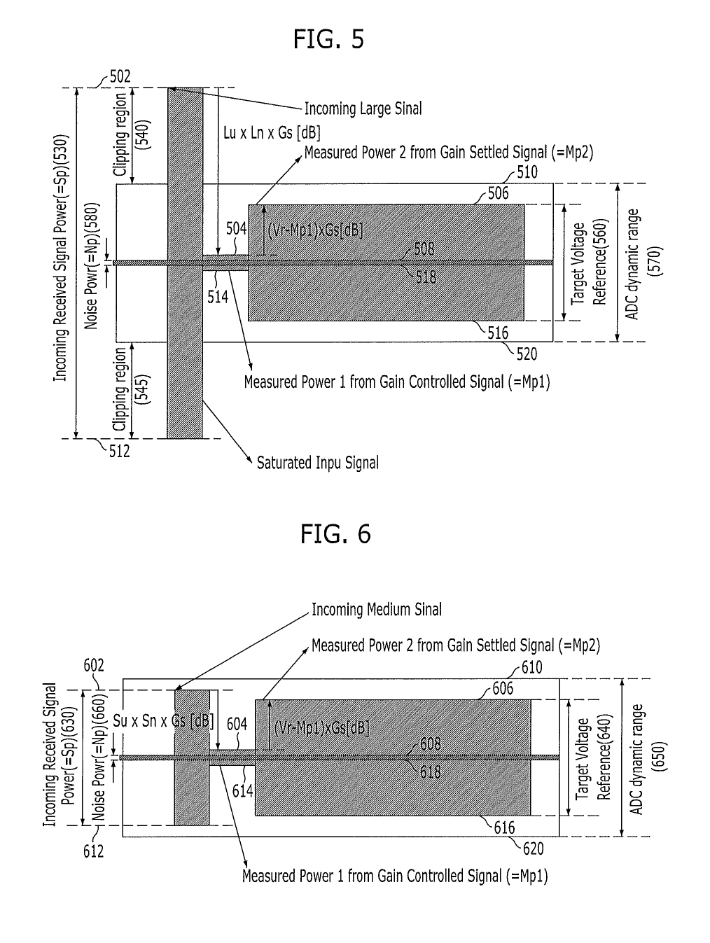

The SNR calculator 126 calculates an SNR based on the gain control value calculated by the AGC 124 and the amplification gain values of the amplifiers 106 and 108. The calculated SNR is decided by a difference of a measured power level (dB) of a received signal and a power level (dB) of noise included in the received signal. Hereinafter, an operation for calculating an SNR in a wireless communication system in accordance with an embodiment of the present invention will be described in detail with reference to FIGS. 5 to 8.

FIGS. 5 to 8 are diagrams for describing an operation for calculating an SNR in a data receiving apparatus of a wireless communication system in accordance with an embodiment of the present invention. FIGS. 5 to 7 are diagrams for describing an operation for calculating an SNR based on a power level of a received signal input to the ADC 110. FIG. 8 is a diagram illustrating a time period for measuring power levels of signals received through a plurality of antennas and a power level of a noise signal for calculating an SNR.

Referring to FIG. 5, the data receiving apparatus in accordance with an embodiment of the present invention receives signals through a plurality of antennas, amplifies the received signals through the amplifiers 106 and 108, and inputs the amplified signals to the ADC 110. The amplified signals input to the ADC 110 may be saturated. That is, the amplified signals may have a power level not in an ADC dynamic range of the ADC 110. In this case, the measured power level thereof or a correlation value thereof is inaccurate because the power level of the signal exceeds the ADC dynamic range of the ADC 110. Accordingly, the data receiving apparatus in accordance with an embodiment of the present invention performs carrier sensing based on a saturation state based scheme to sense the power levels of the amplified signals input to the ADC 110.

Then, the data receiving apparatus in accordance with an embodiment of the present invention recognizes that the received signal has the saturation state by the carrier sensing. Accordingly, the AGC 124 performs a large gain control loop as described above to reduce the power levels 502 and 512 of the input signal as much as a large gain update value (LU) stored in a programmable register. The AGC 124 repeatedly performs the large gain control loop until the received signal becomes not saturated. While repeatedly performing the large gain control loop, a large gain update value Lu is reduced to be corresponding to a gain control step Gs according to the properties of the amplifiers 106 and 108 as many as repetition times. That is, the large gain update value Lu is reduced to a first level Mp1 504 and 514 in the ADC dynamic range 570 of the ADC 110 or a predetermined target power level range 560. The gain control step Gs is decided according to a signal amplification property of the amplifiers 106 and 108 and denotes an amplification gain control interval between the LNA 106 and the VGA 108.

Then, the data receiving apparatus in accordance with an embodiment of the present invention compensates the received signal power level (Measured power 1 (Mp1)) as much as a difference ((Vr−Mp1)×Gs) between the received signal power level (Mp1) and the target voltage reference (Vr) 560 and reflects the compensated power level to a final amplification gain value. Accordingly, the power level of the received signal is changed from the first level Mp1 to a second level Mp2. Here, the second level Mp2 becomes the predetermined target power level.

The data receiving apparatus in accordance with an embodiment of the present invention calculates a final received signal power level by calculating an average value of the controlled signal power level through the large gain control loop and the measured signal power level. Here, the measured power level of the received signal is measured through the power measuring unit 300. A power level of a noise signal included in the received signal is decided as a noise peak value from a reception antenna to the ADC 110. Or, the power level of the noise signal is decided as shown in FIG. 8. The data receiving apparatus in accordance with an embodiment of the present invention can further accurately calculate an SNR by calculating the received signal power and the noise signal power as described above.

That is, since the measured power level 502, 512 of the received signal exceeds the ADC dynamic range 570, the data receiving apparatus in accordance with an embodiment of the present invention reduces the power level of the received signal to the first level Mp1 504 and 514, which is a not-saturated power level or in the target power level range 560, by repeatedly performing a large gain control loop with a large gain update value Lu. After performing the large gain control loop, the data receiving apparatus in accordance with an embodiment of the present invention amplifies the controlled power level from the Mp1 504, 514 to a target power level Mpg 506, 516. That is, the controlled power level is amplified as much as a difference between the target power level gain value Vr and the first level Mp1.

After amplification, the power level of the received signal becomes the second level Mpg 506 and 516. Here, a signal power range Sp 530 of a saturated signal input to the ADC 110 is decided by the power level 502 and 512 of the saturated signal as shown in FIG. 5. Also, clipping regions 540 and 545 are decided by a difference between the signal power range Sp 530 of the saturated signal and the operation power levels 510 and 520 of the ADC 110. Further, the range 560 of the target power level is in the ADC dynamic range 570 of the ADC 110, and the power level of the noise signal included in the received signal is in the first level Mp1 504 and 514.

As described above, the data receiving apparatus in accordance with an embodiment of the present invention calculates an SNR by performing an automatic gain control process such as a large gain control loop when a saturated signal input to the ADC 110 after the signal is received through a plurality of antennas and amplified by the amplifiers 106 and 108. Such an SNR calculation through a large gain control loop can be expressed as Equation 1 below:

$$\begin{matrix}S N R = Sp [ dB ] - Np [ dB ] \\ = ( Sp 1 [ dB ] - Np [ dB ] + Sp 2 [ dB ] - Np [ dB ] ) / 2 \\ = \{ ( Lu \times L n + Mp 1 - Np ) + ( Lu \times L n - ( Vr - Mp 1 ) + \\ Mp 2 - Np ) \} \times Gs / 2 [ dB ] \\ = \{ ( Lu \times L n + Mp 1 - Np ) + ( Mp 2 - Vr ) / 2 \} \times Gs [ dB ]\end{matrix} \qquad Eq . 1$$

In Equation. 1, Sp denotes a power level of a signal input to the ADC 110. That is, Sp indicates a received signal power measured by the data receiving apparatus. Np denotes a power level of a noise signal included in a received signal. Sp1 indicates a first measured power level of a received signal among received signals buffered for a predetermined time. That is, Sp1 indicates an initially measured power level of a received signal. Sp2 denotes the last measured power level of a received signal.

Referring to FIG. 6, the data receiving apparatus in accordance with an embodiment of the present invention receives signals through a plurality of antennas, amplifies the received signals through the amplifiers 106 and 108, and inputs the amplified signals to the ADC 110. The amplified signals input to the ADC 110 may be not saturated. That is, the amplified signals may have a power level within an ADC dynamic range 650 of the ADC 110. The power level 602 and 612 of the received signal is within the ADC dynamic range 650 of the ADC 110 as described above and exceeds the predetermined target power level range 640. In this case, the AGC 124 performs a small gain control loop and reduces the power level 602 and 612 as much as a small gain update value Su stored in a programmable register. The AGC 124 may repeatedly perform the small gain control loop until the power level 602 and 612 of the received signal becomes included in a target power level range 640. The power level 602 and 612 of the received signal is reduced as much as a gain control step Gs according to the property of the amplifiers 106 and 108 as many as the repetition times Sn. That is, the power level 602 and 612 is reduced to a first level Mp1 which is included in the target power level range 560. The gain control step Gs is decided according to a signal amplification property of the amplifiers 106 and 108 and means controlling a gain difference between the LNA 106 and VGA 108.

The data receiving apparatus in accordance with an embodiment of the present invention compensates the power level Mp1 of the received signal as much as a difference ((Vr−Mp1)×Gs) between the power level Mp1 and the target power level range 660 and reflects the compensated power level to a final amplification gain value. Accordingly, the power level Mp1 of the received signal becomes a second level Mp2. The Mp2 denotes a predetermined target power level.

The target power level gain value Vr is decided by a quality of a received signal. Such a quality of received signal may be determined based on signal distortion or an SNR corresponding to signal clipping according to a peak value rate during Fast Fourier Transform (FFT) performed to transmit and receive a signal in a wireless communication system. That is, the target power level gain value Vr is decided as an average value for optimally decoding or restoring a received and amplified signal within an ADC dynamic range 640 of the ADC 110. The quality of received signal may be calculated from parameters such as an Error Vector Magnitude (EVM), a Packet Error Rate (PER).

The data receiving apparatus in accordance with an embodiment of the present invention estimates a final signal power level by calculating an average power level of the calculated signal power level obtained through the small gain control loop and the measured signal power level. Here, the measure signal power level is obtained by the power measuring unit 300. The power level of the noise signal included in the received signal is decided as a noise peak value from the reception antenna to the ADC 110, or decided as shown in FIG. 8. Accordingly, the data receiving apparatus in accordance with an embodiment of the present invention can accurately calculate an SNR by calculating the received signal power level and the noise signal power level as described above.

That is, the data receiving apparatus in accordance with an embodiment of the present invention controls the received signal power level to the first level Mp1 604 and 614 within the target power level range 640 by repeatedly performing the small gain control loop as many as Sn times with a small gain update value Su because the measure power level 602 and 612 of the received signal is not saturated. That is, the measured power level is in the ADC dynamic range 650 of the ADC 110. After repeatedly performing the small gain control loop, the data receiving apparatus in accordance with an embodiment of the present invention amplifies the power level of the received signal as much as a difference between the first measured power Mp1 and the target power level gain value Vr in order to amplify the initial power level of the received signal within the target power level range 640. That is, the first measured power level Mp1 of the received signal is amplified to a second power level Mp2 606 and 616.

If such an amplified power level of the received signal is calculated, it becomes the second level Mp2 606 and 616. As shown in FIG. 6, a signal power range Sp 630 of an unsaturated signal inputted to the ADC 110 is decided by the power level 602 and 612 of the unsaturated signal. Further, the target power level range 640 is included in the ADC dynamic range 650 of the ADC 110, and the power level range 660 of the noise signal included in the received signal is included in the first level Mp1 604 and 614.

As described above, the data receiving apparatus in accordance with an embodiment of the present invention calculates an SNR by performing an automatic gain control process such as a small gain control loop when an unsaturated signal input to the ADC 110 after received through a plurality of reception antennas and amplified by the amplifiers 106 and 108. Such an SNR calculation through a small gain control loop can be expressed as Equation 2 below:

$$\begin{matrix}S N R = Sp [ dB ] - Np [ dB ] \\ = ( Sp 1 [ dB ] - Np [ dB ] + Sp 2 [ dB ] - Np [ dB ] ) / 2 \\ = \{ ( Su \times Sn + Mp 1 - Np ) + ( Su \times Sn - ( Vr - Mp 1 ) + \\ Mp 2 - Np ) \} \times Gs / 2 [ dB ] \\ = \{ ( Su \times Sn + Mp 1 - Np ) + ( Mp 2 - Vr ) / 2 \} \times Gs [ dB ]\end{matrix} \qquad Eq . 2$$

In Equation 2, Sp denotes a power level of a received signal input to the ADC 110. Sp indicates a measured power level of a received signal, measured by the data receiving apparatus in accordance with an embodiment of the present invention. Np denotes a power level of a noise signal included in a received signal. Sp1 indicates a first measured power level of a received signal among received signals buffered for a predetermined time. That is, Sp1 indicates an initially measured power level of a received signal. Sp2 denotes the last measured power level of a received signal.

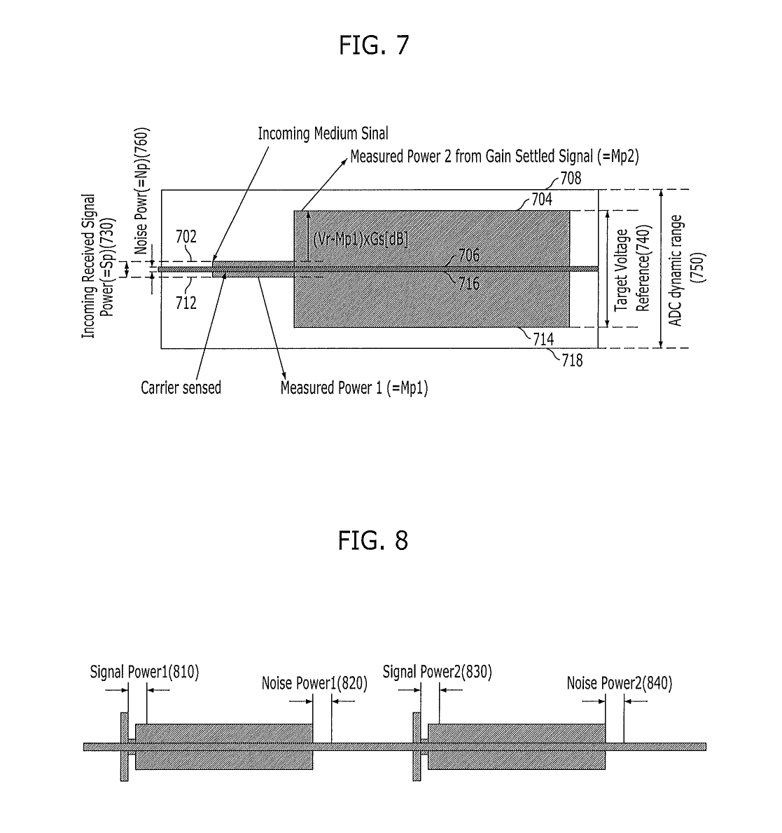

Referring to FIG. 7, the data receiving apparatus in accordance with an embodiment of the present invention receives signals through a plurality of antennas, amplifies the received signals through the amplifiers 106 and 108, and inputs the amplified signals to the ADC 110. The amplified signals input to the ADC 110 may be unsaturated. That is, the amplified signals may have a power level included in a predetermined target power level range 740. In this case, a signal is significantly attenuated due to signal distortion, noise, and interference when the signal is exchanged between a transmission antenna and a reception antenna. The data receiving apparatus in accordance with an embodiment of the present invention compensates the power level Mp1 of the received signal as much as a difference (vr−Mp1) between the first level Mp1 and the target power level range 660 and reflects the compensated signal to a final amplification gain value. Accordingly, the power level of the received signal is changed from the Mp1 to a second measured power level (Mp2). Here, the second measured power level Mp2 becomes a predetermined target power level.

The data receiving apparatus in accordance with an embodiment of the present invention calculates a final power level of a received signal by calculating an average of the calculated power level of the received signal and the measured power level of the received signal. As described above, the measured power level of the received signal is obtained through the power measuring unit 300. The power level of the noise signal included in the received signal is decided as a noise peak value from the reception antenna to the ADC 110 or decided as shown in FIG. 8. The data receiving apparatus in accordance with an embodiment of the present invention can further accurately calculate an SNR by calculating the power level of the received signal and the power level of the noise signal as described above.

That is, the data receiving apparatus in accordance with an embodiment of the present invention amplifies the received signal as much as a difference between the target power level gain value Vr and the first measured power level Mp1 to amplify the first measured power level Mp1 702 and 712 of the received signal to the target power level 704 and 714 because the measured power level of the received signal is the first measure power level Mp1 within the target power level range 740.

If the amplified power level of the received signal is calculated, it becomes the second measured power level Mpg 704 and 714. Here, the signal power range Sp 730 of a received signal input to the ADC 110 is decided because the power level is the first measured power level Mp1 within the target power level range 740 as shown in FIG. 7. Also, the target power level range 740 is included in the ADC dynamic range 750 of the ADC 110, and a power level range 760 of a noise signal included in a received signal is included in the first measured power level Mp1 702 and 712.

As described above, the data receiving apparatus in accordance with an embodiment of the present invention calculates an SNR by performing an automatic gain control process when the received signal has a first measured power level Mp1 included in the target power level range 740 after signals are rejected through a plurality of reception antennas, amplified through the amplifiers 106 and 108, and input to the ADC 110. Such an SNR calculation can be expressed as Equation 3 below:

$$\begin{matrix}S N R = Sp [ dB ] - Np [ dB ] \\ = ( Sp 1 [ dB ] - Np [ dB ] + Sp 2 [ dB ] - Np [ dB ] ) / 2 \\ = \{ ( Mp 1 - Np ) + ( Vr - Mp 1 ) + Mp 2 - Np \} \times Gs / 2 [ dB ] \\ = \{ ( Mp 1 - Np ) + ( Mp 2 - Vr ) / 2 \} \times Gs [ dB ]\end{matrix} \qquad Eq . 3$$

In Equation 3, Sp denotes a power level of a received signal input to the ADC 110. Sp indicates a measured power level of a received signal, measured by the data receiving apparatus in accordance with an embodiment of the present invention. Np denotes a power level of a noise signal included in a received signal. Sp1 indicates a first measured power level of a received signal among received signals buffered for a predetermined time as shown in FIG. 4. That is, Sp1 indicates an initially measured power level of a received signal. Sp2 denotes the last measured power level of a received signal.

When the received signal inputting to the ADC 110 is saturated or when the received signal inputting to the ADC 110 is unsaturated and exceeds or within the predetermined target power level range after the received signal is received through a plurality of reception antennas and amplified by the amplifiers 106 and 108, As described above, the data receiving apparatus in accordance with an embodiment of the present invention accurately calculates an SNR using the AGC 124 by reflecting a gain control value and an amplification gain value of the amplifiers 106 and 108 to the received signal. For example, the data receiving apparatus in accordance with an embodiment of the present invention accurately calculates an SNR using Equations 1 to 3. That is, the data receiving apparatus in accordance with an embodiment of the present invention accurately calculates an SNR using an average of a compensated signal power level through the AGC 124 and a measured signal power level. Particularly, the data receiving apparatus in accordance with an embodiment of the present invention calculates an average signal power level of a compensated signal power level calculated by compensating a received signal power level as much as a gain control value and an amplification gain value of the amplifiers 106 and 108, a compensated signal power level calculated by compensating a difference between a target power level and a measured power level, and an average of the measured signal power levels, and accurately calculates an SNR using the calculated average signal power level and a noise signal power level. Further, the data receiving apparatus in accordance with an embodiment of the present invention can calculates an SNR using not only the received signals but also a noise signal included in the received signals. Hereinafter, a time period for measuring power levels of signals received through a plurality of antennas and a power level of a noise signal in accordance with an embodiment of the present invention will be described with reference to FIG. 8.

Referring to FIG. 8, the data receiving apparatus in accordance with an embodiment of the present invention calculates an SNR from signals received through a plurality of reception antennas by buffering a power level of a noise signal to a programmable register. The power level of the noise signal means a power level of noise component for the received signal within the data receiving apparatus. Since the noise component is a value not changing for a corresponding data receiving apparatus, the data receiving apparatus in accordance with an embodiment of the present invention can use the noise signal power level to calculate an SNR. Here, performance, reliability, and accuracy of calculating an SNR may be deteriorated when a power level of a noise signal is changed in a transmitter transmitting a signal to the data receiving apparatus, when an environment or a state of a channel formed between a transmission antenna and a reception antenna changes, or when a power level of a noise signal changes in the data receiving apparatus. Accordingly, it is preferable that the data receiving apparatus in accordance with an embodiment of the present invention calculates an SNR by updating a noise signal power level by a unit of a packet.

The data receiving apparatus in accordance with an embodiment of the present invention measures a received signal power level and a noise signal power level at signal power measuring periods 810 and 830 for measuring a received signal power level by a unit of a packet and at noise signal power measuring periods 820 and 840 for measuring a noise signal power level. The received signal power level is measured at a preamble 810 and 830 of a packet, and the noise signal power level is measured at predetermine time periods 820 and 840 after a packet ends. In case of a WLAN system having 2 us as an interval between packets, the data receiving apparatus in accordance with an embodiment of the present invention measures the noise signal power level at the intervals between packets as noise signal power measuring periods 820 and 840. Further, the data receiving apparatus in accordance with an embodiment of the present invention measures a received signal power level of a received signal by performing an automatic gain control operation of the AGC 124 as described above.

Here, the data receiving apparatus in accordance with an embodiment of the present invention calculates an SNR at a ratio among a noise signal power level measured during a time period after a previous packet ends, for example, a noise signal power level measured at a first noise signal power level measuring period 820 and a received signal power level measured during a preamble of a current packet, for example, a received signal power level measured at a second received signal power level measuring period 830. Such an SNR calculation can be expressed as Equation 4 blow:

SNR=Signal Power 2/Noise Power 1 Eq. 4

In Equation 4, Signal Power 2 denotes a received signal power level measured at the second received signal power level measuring period 830. Noise power 1 denotes a noise signal power level measured at the first noise signal power level measuring period 820.

When the data receiving apparatus in accordance with an embodiment of the present invention calculates an SNR by measuring a noise signal power level by a unit of a packet, a noise signal power level is measured at a predetermined time period as a noise signal power level measuring period after a packet ends that can accurately identify a period for receiving noise signals. The data receiving apparatus in accordance with an embodiment of the present invention can accurately calculate a reliable SNR by determining whether a measured noise signal power level is a proper value for calculating an SNR or not through a controller. In other words, the data receiving apparatus in accordance with an embodiment of the present invention uses only noise signal power levels included in between a maximum noise signal power level and a minimum noise signal power level among noise signals measured from a plurality of received signals. Further, the data receiving apparatus in accordance with an embodiment of the present invention calculates an SNR using an average value of noise signal power levels measured from a plurality of previously received signals for noise signal power levels not in between the maximum noise signal power level and the minimum noise signal power level. Accordingly, the data receiving apparatus in accordance with an embodiment of the present invention can calculates a further accurate and reliable SNR by preventing an error in measuring a noise signal power level.

That is, the data receiving apparatus of a wireless communication system in accordance with an embodiment of the present invention accurately and efficiently calculates an SNR. Particularly, the data receiving apparatus in accordance with an embodiment of the present invention measures received signal power levels based on a gain control value and an amplification gain value of the AGC 124, the LNA 106, and the VGA 108 at a digital MODEM after controlling a gain and before controlling a gain. The data receiving apparatus in accordance with an embodiment of the present invention can accurately calculate an SNR based on a ratio of an average power level of the measured received signal power levels and the noise signal power level. Particularly, the data receiving apparatus in accordance with an embodiment of the present invention calculates an accurate SNR by calculating a ratio between a received signal power level and a noise signal power level through measuring a power level of a received signal input to the ADC 110 because the noise signal power level changes by controlling a gain of a received signal. Here, the data receiving apparatus in accordance with an embodiment of the present invention can calculate an SNR from a minimum power level of a received signal that can be restored to an operation range of the amplifiers 106 and 108.

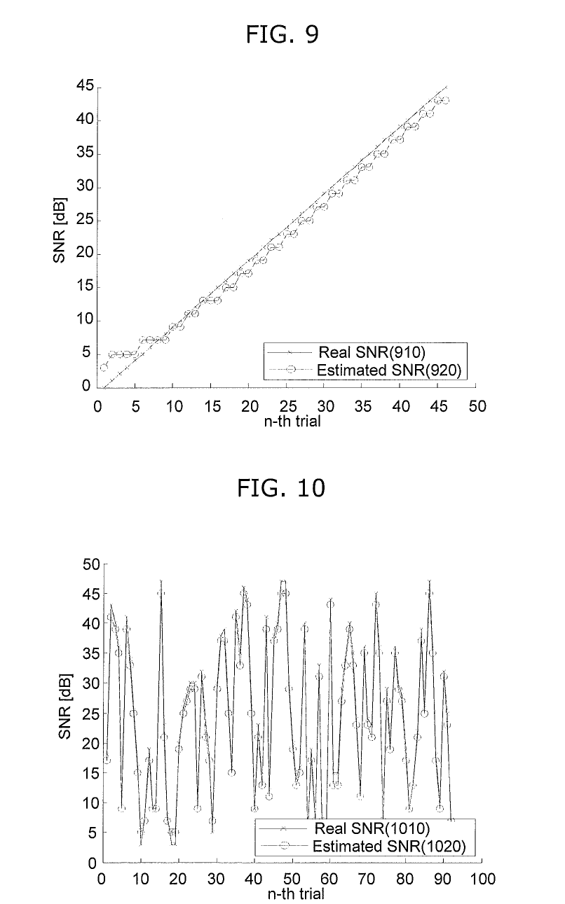

In case of a multi-antenna high speed wireless communication system, the data receiving apparatus in accordance with an embodiment of the present invention can calculate a further accurate and reliable SNR for signals received through a plurality of reception antennas. Since the data receiving apparatus in accordance with an embodiment of the present invention calculates the accurate SNR through an automatic gain control operation of the AGC 124 without additional devices, it minimizes system complexity and power consumption. Hereinafter, an SNR calculated by the data receiving apparatus in accordance with an embodiment of the present invention will be described in detail with reference to FIGS. 9 to 15.

FIGS. 9 to 15 are graphs schematically illustrating an SNR calculated by a data receiving apparatus of a wireless communication system in accordance with an embodiment of the present invention.

As shown in FIG. 9, the data receiving apparatus in accordance with an embodiment of the present invention calculates an SNR 920 very close to an ideal SNR 910. Since the calculated SNR 920 is very close to the ideal SNR 910, the graph of FIG. 9 shows that the data receiving apparatus in accordance with an embodiment of the present invention calculates accurate and reliable SNR.

As shown in FIG. 10, the data receiving apparatus in accordance with an embodiment of the present invention calculates an SNR 1020 by measuring a power level of a received signal and a power level of a noise signal in a unit of a packet when an environment or a state of a channel formed between a transmission antenna and a reception antenna abruptly changes. Since the calculated SNR 1020 is very close to an ideal SNR 1010, the graph of FIG. 10 shows that the data receiving apparatus in accordance with an embodiment of the present invention calculates accurate and reliable SNR.

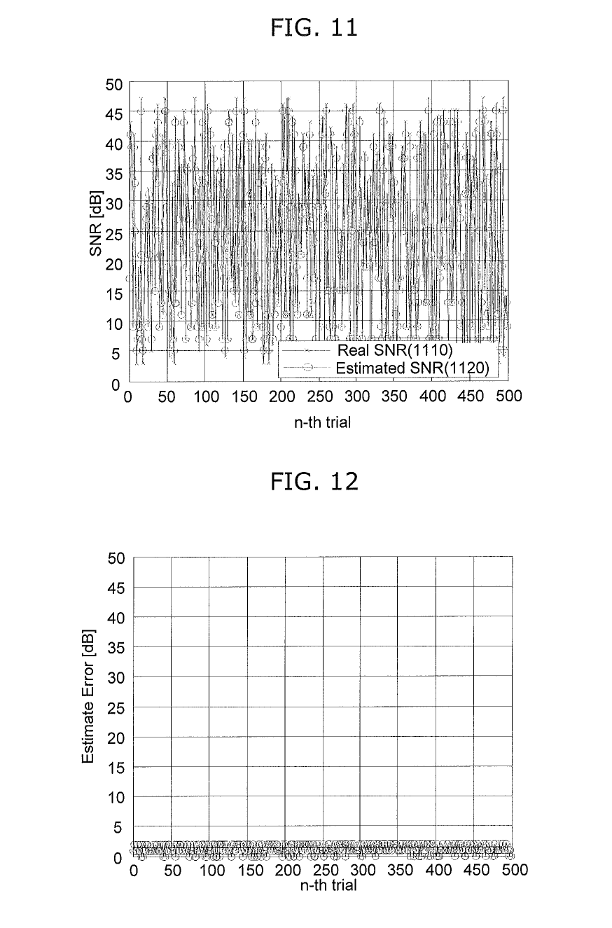

Although the data receiving apparatus in accordance with an embodiment of the present invention repeatedly calculates an SNR, for example, 500 times, as shown in FIG. 11, a maximum difference between a calculated SNR 1120 and an ideal SNR 1110 is about 2 dB as shown in FIG. 12. According to the statistical result, about 60% of calculated SNR has an error rate of about 1 dB, and about 40% of calculated SNR has an error rate of about 2 dB. Accordingly, the data receiving apparatus in accordance with an embodiment of the present invention calculates an accurate and reliable SNR.

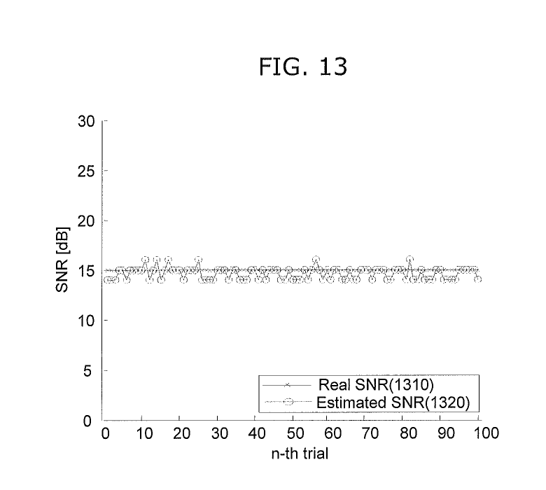

As shown in FIG. 3, the data receiving apparatus in accordance with an embodiment of the present invention calculates an SNR 1320 very close to an ideal SNR 1310 although a power level of a received signal used for calculating an SNR is randomly changed from −80 dBm to −5 dBm. Accordingly, the graph of FIG. 13 clearly shows that the data receiving apparatus in accordance with an embodiment of the present invention calculates an accurate and reliable SNR.

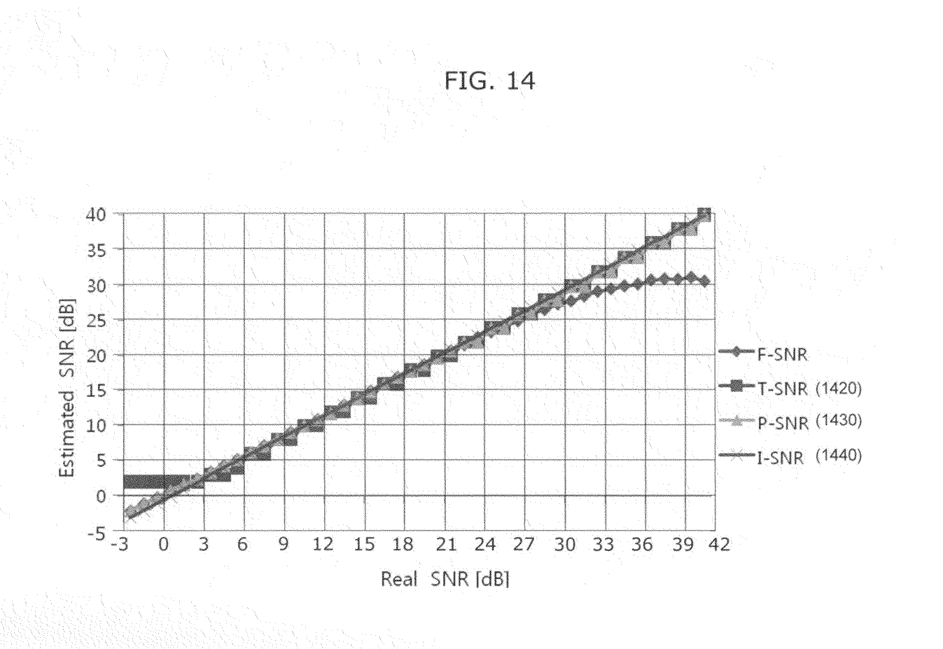

As shown in FIG. 14, the data receiving apparatus in accordance with an embodiment of the present invention calculates an SNR 1420 using a received signal in a time domain before FFT as described above. That is, the calculated SNR 1420 minimizes complexity compared to an SNR 1410 calculated using a received signal in a frequency domain. Further, the data receiving apparatus in accordance with an embodiment of the present invention calculates an SNR adaptively using a received signal in a time domain or a received signal in a frequency domain in order to calculate a further accurate SNR. Since the graph of FIG. 14 shows that the calculated SNR 1430 is very close to an ideal SNR 1440, the data receiving apparatus in accordance with an embodiment of the present invention can calculate an accurate and reliable SNR. Wherein, the SNR 1410 is an F-SNR, which is an SNR estimated in a frequency domain, the SNR 1420 is T-SNR, which is an SNR estimated in a time domain (T-SNR), the SNR 1430 is a P-SNR, winch is an SNR estimated in a hybrid domain of a frequency domain and a time domain, and the SNR 1440 is I-SNR, which is an SNR ideal estimated in a frequency domain and a time domain. And, the data receiving apparatus in accordance with an embodiment of the present invention uses the P-SNR 1430, more particularly the data receiving apparatus uses an SNR estimated in a frequency domain of the P-SNR 1430, when the SNR, i.e. P-SNR 1430 is smaller than a predetermined dBm, and the data receiving apparatus uses an SNR estimated in a time domain of the P-SNR, when the SNR, i.e. P-SNR 1430 is larger than the predetermined dBm, in the P-SNR 1430.

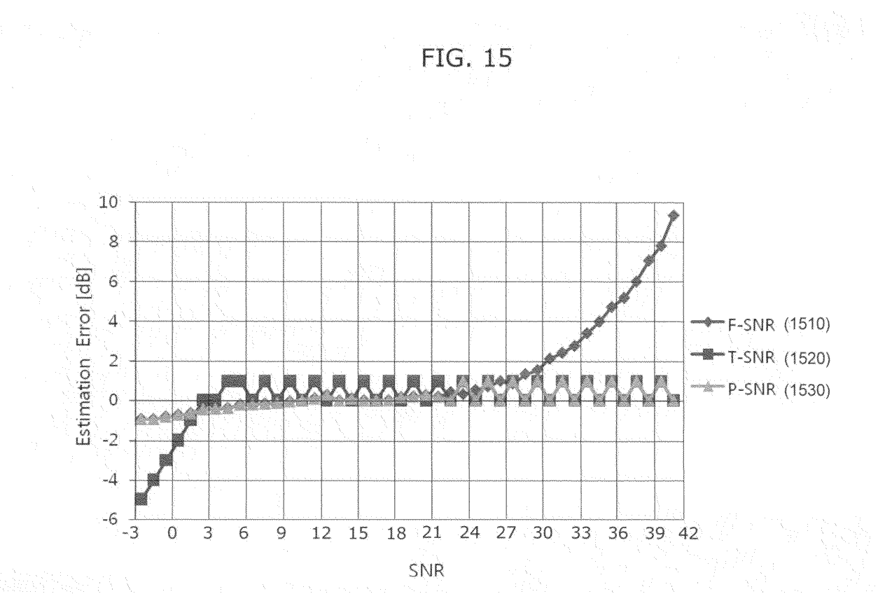

The data receiving apparatus in accordance with an embodiment of the present invention calculates an SNR using a received signal in a time domain or adaptively using a received signal in a time domain or a received signal in a frequency domain. As shown in FIG. 15, an SNR 1520 calculated in the time domain or an SNR 1530 calculated adaptively in the time domain or in the frequency domain has an SNR calculation error rate significantly lower than that of an SNR 1510 calculated using a received signal in a frequency domain. Accordingly, the data receiving apparatus in accordance with an embodiment of the present invention calculates an accurate and reliable SNR.

Here, the number of bits of a data processor is maximally reduced in order to lower power consumption efficiency and a manufacturing cost of a high speed wireless communication system. Since a quantization error and a processing error are generated in data of a received signal input through a data processor having such limited bit number, an SNR 1510 calculated using a received signal in the frequency domain has an error rate greater than the SNRs 1520 and 1530 calculated by other methods. Particularly, in a low SNR, the influence of the quantization error or the processing error is smaller than that of a channel noise and a thermal noise in a wireless communication system. Accordingly, the quantization error and the processing error do not significantly influence the error rate of the calculated SNR 1510. However, when an SNR of a received signal increases, the quantization error and the processing error significantly influences the calculated SNR 1510. Accordingly, an error rate of the calculated SNR 1610 is greater than that of the calculated SNR 1520 or 1530. Further, there is a limit in a power level range of a received signal used for calculating an SNR. That is, there is a limit in an operation range of constituent elements of a data receiving apparatus processing a received signal. Due to such a limit, an error rate of the calculated SNR 1510 is greater than error rates of the SNRs 1520 and 1530 calculated by other methods.

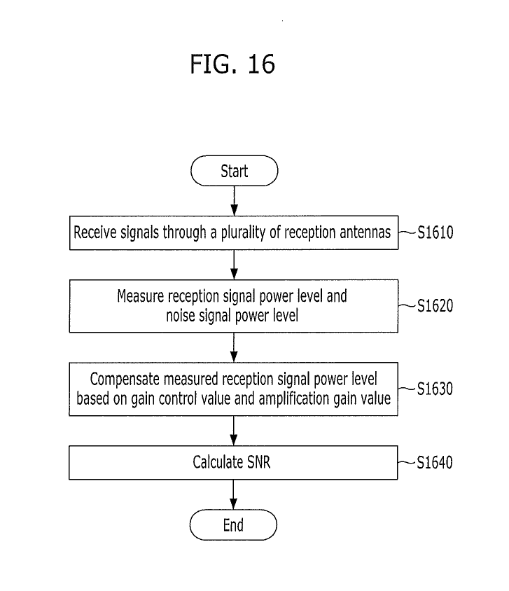

When the data receiving apparatus in accordance with an embodiment of the present invention calculates an SNR using a received signal in a time domain, an error rate of the calculated SNR 1520 increases for an SNR smaller than a predetermined dBm. Accordingly, an overall system performance is reduced. For example, an SNR error rate of about 1 dB is sustained for an SNR greater than 2 dB. However, the SNR error rate increases for an SNR lower than 2 dB. Accordingly, the overall system performance can be decreased. As described above, the data receiving apparatus in accordance with an embodiment of the present invention calculates an SNR adaptively using a received signal in a time domain or a received signal in a frequency domain to minimize an error rate of the calculated SNR 1530. Accordingly, the data receiving apparatus in accordance with an embodiment of the present invention calculates an accurate and reliable SNR. Hereinafter, a method for calculating an SNR of a data receiving apparatus in a wireless communication system in accordance with an embodiment of the present invention will be described with reference to FIG. 16.

FIG. 16 is a flowchart illustrating a method for calculating an SNR of a data receiving apparatus in a wireless communication system in accordance with an embodiment of the present invention.

Referring to FIG. 16, at step S1610, the data receiving apparatus in accordance with an embodiment of the present invention receives packets. That is, the data receiving apparatus in accordance with an embodiment of the present invention receives signals through a plurality of reception antennas.

At step S1620, when the amplifiers 106 and 108 amplify the received signals, the data receiving apparatus in accordance with an embodiment of the present invention measures power levels of the amplified signals and also measures a power level of a noise signal. The data receiving apparatus in accordance with an embodiment of the present invention measures the received signal power level at a preamble of the received packet and measures the noise signal power level at a predetermined time period after the packet ends. That is, the data receiving apparatus in accordance with an embodiment of the present invention measures a power level of each received signal and a power level of a noise signal by a unit of a packet. Further, the data receiving apparatus in accordance with an embodiment of the present invention measures a power level of each signal received through a plurality of reception antennas, determines the largest power level among the measured power levels of the received signals, and calculates an average power level of the received signals except a received signal having the largest power level.

At step S1630, the data receiving apparatus in accordance with an embodiment of the present invention calculates a gain control value of the AGC 124 and amplification gain values of the amplifiers 106 and 108 by performing an automatic gain control process through the AGC 124 and compensates the measured power levels of the received signals based on the calculated gain control value and the calculated amplification gain values. Here, the data receiving apparatus in accordance with an embodiment of the present invention calculates a gain control value and an amplification gain value for a power level of a received signal corresponding to the largest power level among the measured power levels of the received signals received through the plurality of reception antennas. Then, the data receiving apparatus in accordance with an embodiment of the present invention determines whether a received signal corresponding to the largest power level is saturated or not or is included in a target power level range or not.

When a power level of a received signal corresponding to the largest power level is a saturation state, the data receiving apparatus in accordance with an embodiment of the present invention compensates the largest power level to be included in the target power level range by repeatedly performing a large gain control process on the received signal based on the calculated gain control value and the calculated amplification gain value. When a power level of a received signal corresponding to the largest power level is not included in the target power lever range, the data receiving apparatus in accordance with an embodiment of the present invention compensates the largest power level to be included in the target power level range by repeatedly performing a small gain control process on the received signal based on the calculated gain control value and the calculated amplification gain value. When a power level of a received signal corresponding to the largest power level is included in the target power level range, the data receiving apparatus in accordance with an embodiment of the present invention compensates the largest power level to the target power level based on the calculated gain control value and the calculated amplification gain value for the received signal having the maximum power level. Then, the data receiving apparatus in accordance with an embodiment of the present invention compensates the largest power level included in the target power level range to the target power level by compensating the largest power level as much as a target power level gain value.

At step S1640, the data receiving apparatus in accordance with an embodiment of the present invention calculates an SNR by calculating a ratio of the measured power levels of received signals, an average power level of the compensated power levels of received signals, and the power level of the noise signal.

As described above, the data receiving apparatus in accordance with an embodiment of the present invention calculates a further accurate and reliable SNR while minimizing system complexity and power consumption. Further, the data receiving apparatus in accordance with an embodiment of the present invention performs channel estimation and data restoration using the accurate and reliable SNR. Accordingly, the data receiving apparatus in accordance with an embodiment of the present invention can not only stably receive data but also process data at high speed.

As described above, the data receiving apparatus in accordance with an embodiment of the present invention accurately determines a channel state at a high speed through a simple structure with a low power consumption using an analog data signal transmitted through a wireless channel. Therefore, the data receiving apparatus in accordance with an embodiment of the present invention can accurately and stably receive data transmitted through a wireless channel in a high speed. Further, the data receiving apparatus in accordance with an embodiment of the present invention has low complexity, requires low power consumption, and receives data at a high speed. Therefore, the data receiving apparatus in accordance with an embodiment of the present invention can improve an overall system performance.

As described above, the data receiving apparatus in accordance with an embodiment of the present invention accurately determines a channel state of a wireless channel where data is transmitted at high speed in a time domain using typical constituent elements of a receiver. Accordingly, the data receiving apparatus in accordance with an embodiment of the present invention has low complexity and requires low power consumption. Further, since the data receiving apparatus in accordance with an embodiment of the present invention determines a reliable channel state in a wide measuring range using signals of a plurality of data reception paths, the data receiving apparatus in accordance with an embodiment of the present invention can increase a data transmit rate and a processing rate. As a result, the data receiving apparatus in accordance with an embodiment of the present invention can improve an overall system performance.

Moreover, the data receiving apparatus in accordance with an embodiment of the present invention can estimate a further accurate signal to noise ratio (SNR) in a further wider measuring range by adaptively using a frequency domain based SNR estimation method for a bad channel state and using a time domain based SNR estimation method for a good channel state.

While the present invention has been described with respect to the specific embodiments, it will be apparent to those skilled in the art that various changes and modifications may be made without departing from the spirit and scope of the invention as defined in the following claims.

What is claimed is:

1. A method for receiving data in a wireless communication system, comprising:
receiving data through one antenna or a plurality of reception antennas;
measuring received signal power levels and a noise power level from the received data;
calculating a gain control value of an automatic gain control process;
compensating the measured received signal power levels based on the calculated gain compensation value;
calculating a predetermined ratio based on the compensated received signal power levels and the noise power level; and
restoring the received data using the calculated predetermined ratio.

2. The method of claim 1, wherein, in said measuring signal power levels,
the received signal power levels and the noise power level are measured by a unit of a packet, the received signal power levels are measured at a preamble of the packet, and the noise power level is measured at a predetermined time period after the packet ends or before the packet starts.

3. The method of claim 1, wherein, in said measuring signal power levels,
a received signal power level of each signal received through a plurality of antennas is measured, a largest received signal power level is determined among the measured received signal power levels, and an average received signal power level of received signals is calculated by excluding a received signal of the largest received signal power level.

4. The method of claim 3, wherein, in said calculating a gain control value,
a gain control value is calculated for a received signal power level of a received signal corresponding to the largest received signal power level.

5. The method of claim 4, wherein said compensating the measured received signal power levels comprises:
determining whether a received signal corresponding to the largest received signal power level is in a saturation state or not and whether the received signal corresponding to the largest received signal power level is included in a target power level range; and
compensating the largest received signal power level based on the calculated gain control value and the calculated amplification gain value by performing the automatic gain control process corresponding to the determination result.

6. The method of claim 5, wherein, in said compensating the largest received signal power level,
when the received signal corresponding to the largest received signal power level is in the saturation state, the largest received signal power level is compensated to the target power level by performing a large gain control process on the received signal corresponding to the largest power level based on the calculated gain control value and the calculated amplification gain value.

7. The method of claim 6, wherein, in said compensating the largest received signal power level,
the largest received signal power level is compensated to be included in the target power level range by repeatedly performing the large gain control process.

8. The method of claim 5, wherein, in said compensating the largest received signal power level,
when the largest received signal power level is not included in the target power level range, the largest received signal power level is compensated to the target power level by performing a small gain control process on the received signal corresponding to the largest received signal power level based on the calculated gain control value and the calculated amplification gain value.

9. The method of claim 8, wherein, in said compensating the largest received signal power level,
the largest received signal power level is compensated to be included in the target power level range by repeatedly performing the small gain control process.

10. The method of claim 5, wherein, in said compensating the largest received signal power,
when the largest received signal power level is included in the target power level range, the largest received signal power level is compensated to the target power level based on the calculated gain control value and the calculated amplification gain value; and the largest received signal power level included in the target power level range is compensated to the target power level by compensating the largest received signal power level as much as a target power level gain value.

11. The method of claim 1, wherein said calculating a predetermined ratio comprises:
calculating an average received signal power level of the measured received signal power levels and the compensated received signal power levels; and
calculating a Signal-to-Noise Ration (SNR) between the calculated average received signal power and the measured noise power level.

12. The method of claim 11, wherein said calculating an SNR uses an SNR estimated in a hybrid domain of a frequency domain and a time domain;
wherein the SNR estimated in the frequency domain is used for calculating the SNR, when the SNR is smaller than a predetermined dBm, and the SNR estimated in the time domain is used for calculating the SNR, when the SNR is larger than the predetermined dBm.

13. An apparatus for receiving data in a wireless communication system, comprising:
an amplifier configured to receive data through a plurality of reception antennas and amplify the received data;
a measuring unit configured to measure a received signal power level and a signal power level from the amplified data;
an automatic gain controller configured to perform an automatic gain control process for the measured received signal power level and compensate the measured received signal power level based on a gain control value of the automatic gain control process and an amplification gain value of the amplifier; and
a calculator configured to calculate a predetermined ratio based on the compensated received signal power level and the noise power level.

14. The apparatus of claim 13, wherein the measuring unit measures the received signal power level and the noise power level by a unit of a packet, measures the received signal power level at a preamble of the packet, and measures the noise power level at a predetermined time period after the packet ends.

15. The apparatus of claim 13, wherein the measuring unit measures a received signal power level of each signal received through the plurality of reception antennas, determines a largest received signal power level among the measured received signal power levels, and calculates an average received signal power level of received signals except a received signal of the largest received signal power level.

16. The apparatus of claim 15, wherein the automatic gain controller perform the automatic gain control process by calculating an amplification gain value and a gain control value for a received signal power level of a received signal corresponding the largest received signal power level, determining whether a received signal corresponding to the largest received signal power level is in a saturation state or not, and determining whether the largest received signal power level is included in a target power level range.

17. The apparatus of claim 16, wherein when the received signal corresponding to the largest received signal power level is in the saturation state, the automatic gain controller compensates the largest received signal power level to be included in the target power level range by repeatedly performing a large gain control process on a received signal corresponding to the largest received power level based on the calculated gain control value and the calculated amplification gain value.

18. The apparatus of claim 16, wherein when the largest received signal power level is not included in the target power level range, the automatic gain controller compensates the largest received signal power level to be included in the target power level range by repeatedly performing a small gain control process on a received signal corresponding to the largest received signal power level based on the calculate gain control value and the calculated amplification gain value.

19. The apparatus of claim 16, wherein when the largest received signal power level is included in the target power level range, the automatic gain controller compensates the largest received signal power level to the target power level based on the calculated gain control value and the amplification gain value for a received signal corresponding to the largest received signal power level.

20. The apparatus of claim 16, wherein the automatic gain controller compensates the largest received signal power level included in the target power level range to the target power level by compensating the largest received signal power level as much as a target power level gain value.
